(19) United States
(12) Patent Application Publication
(10) Pub. No.: US 2005/0168981 A1
(43) Pub. Date: Aug. 4, 2005

(54) Lamp structure

(75) Inventor: Shang-Chih Chen, Banchiau City (TW)

Correspondence Address: TROXELL LAW OFFICE PLLC, SUITE 1404, 5205 LEESBURG PIKE, FALLS CHURCH, VA, 22041, US

(73) Assignee: Soyee Investments Limited

(21) Appl. No.: 10/766,811

(22) Filed: Jan. 30, 2004

(51) Int. Cl. F21V 9/00

(52) U.S. Cl. 362/231

(57) ABSTRACT

The present invention discloses a lamp structure having a lampshade presenting metallic shine, which achieves sight effect. A mass of metallic string placed in the lampshade is illuminated by an illuminator also accommodated in the lampshade, thus presents metallic shine and achieve sight effect. The colors of the lampshade, the illuminator and metallic string can vary depending on the designs to achieve different sight effects.

### BACKGROUND OF THE INVENTION

1. Field of the Invention

The present invention relates to a lamp structure, and more particularly to a lamp structure having a lampshade presenting metallic shine and sight effect.

2. Description of the Prior Art

Conventionally, the method to make a lamp structure more beautiful or artistic is to modify the shape of the lampshade. However, these designs for the lampshade have encountered the bottleneck and fail to interest the consumers. As a result, they are not helpful to the sale of the conventional lamp structure.

In order to resolve the above problem, an improved lamp structure is disclosed in the present invention.

### SUMMARY OF THE INVENTION

Therefore, the main object of the present invention is to provide a lamp structure, which has a transparent lampshade accommodating a illuminator and a mass of string made of metal, such as stainless steel. The Illuminator illuminates the stainless steel string and thus generates metallic shine and achieves the purpose of sight effect.

The secondary object of the present invention is to provide a lamp structure. By varying the colors of the lampshade and the string, respectively, to achieve the purpose of variation of sight effect.

To achieve the above purposes, the present invention provides a lamp structure including a lampshade having at least one opening, a mass of string made of stainless steel, a base connected with the opening of the lampshade and a illuminator accommodated by the lampshade and electrically connected with the base.

### DESCRIPTION OF THE PREFERRED EMBODIMENT

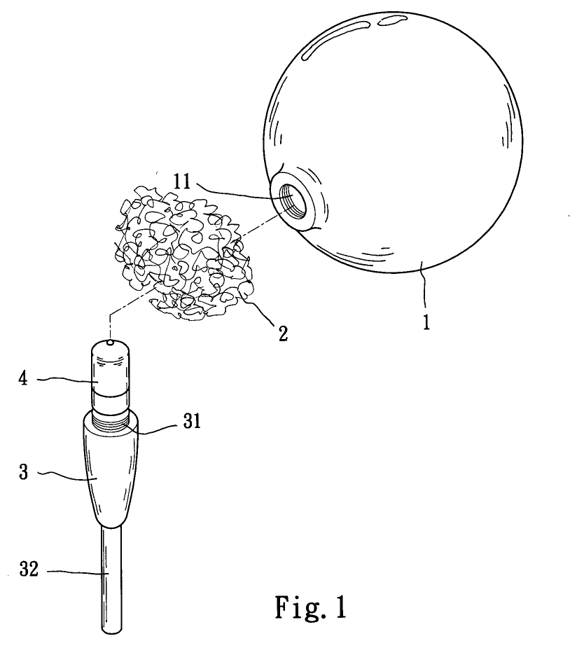

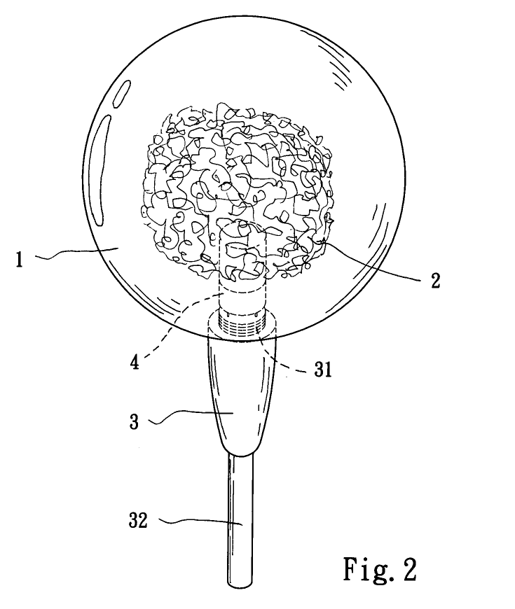

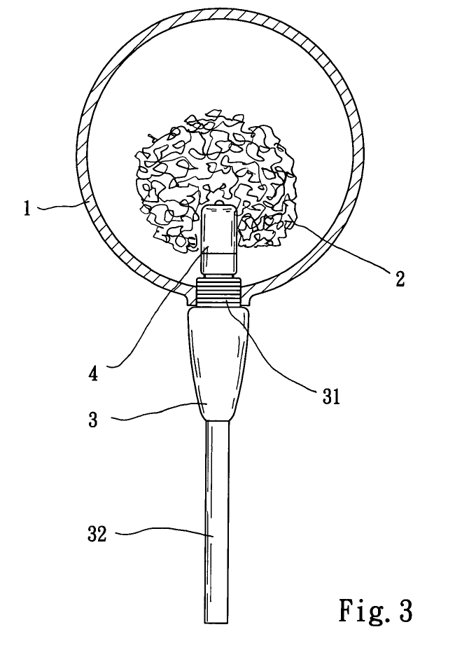

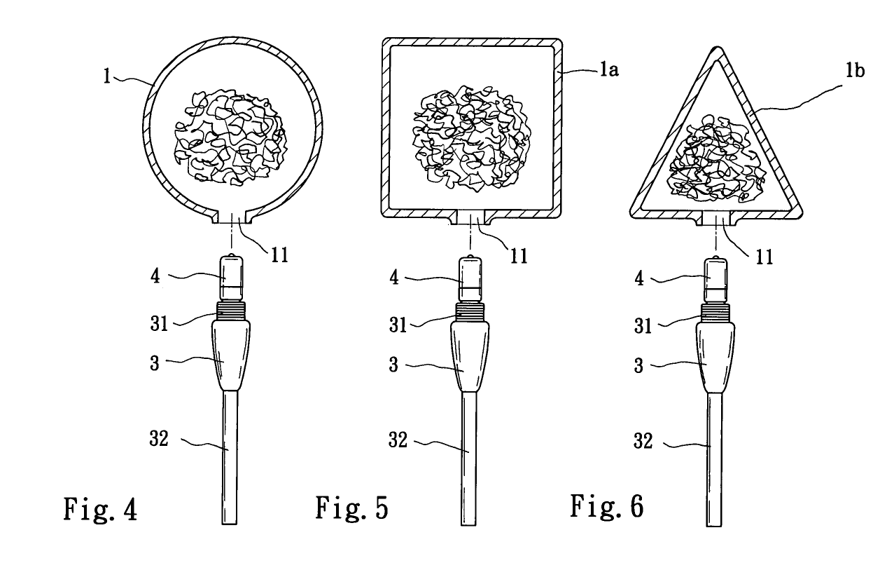

Referring to FIG. 1 through FIG. 4, the present invention provides a lamp structure including a lampshade 1 transparent or translucent for light to pass through, a mass of string 2 made of metal, such as stainless steel, a base 3 and a illuminator 4.

The lampshade 1 includes an opening 11. The mass of string 2 is placed into the lampshade 1 through the opening 11.

The base 3 further includes a connective device 31 and an electrical wire 32. The illuminator 4 is electrically connected with the base 3. The opening 11 of the lampshade 1 corresponds to the connecting device 31. The connecting device 31 of the base 3 can be aligned and connected with the lampshade 1 via the opening 11. As shown in FIGS. 1-4, the connecting device 31 is a thread. Also, there is another thread formed on the inner side of the opening 11, correspondingly. These two threads can be engaged with each other. Meanwhile, after engaging these two threads with each other, the illuminator 4 is placed into the lampshade 1.

The lampshade 1, the string 2 and the illuminator 4 can have or illuminate a variety of colors, respectively. By the illumination of the illuminator 4, the

Besides the exemplary shapes shown in FIG. 1 through FIG. 4, the shapes of the lampshade 1 and the string 2 can also vary as shown in FIG. 5 through FIG. 8, such as an cubic shape 1a, pyramidal or triangular shape 1b, rectangular shape 1c or spherical shape 1d.

Besides the exemplary embodiment shown in FIG. 1 through FIG. 4, the other examples of the illuminator 4 can also be a bulb 4a shown in FIG. 8 or a LED.

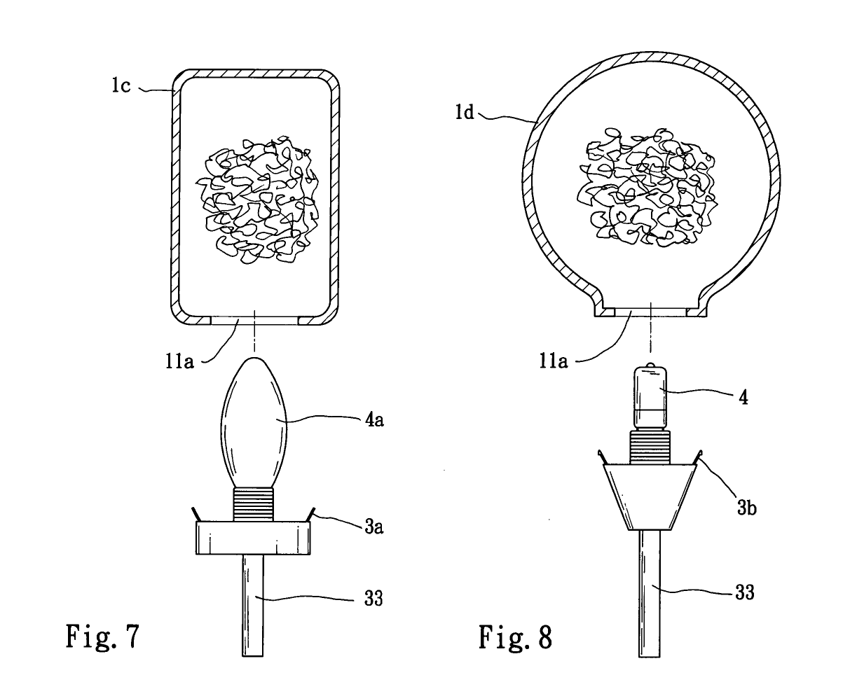

Besides the exemplary embodiment shown in FIG. 1 through FIG. 4, the bases 3a or 3b shown in FIG. 7 and FIG. 8, respectively, can also be the other examples of the base 3. Further, the connecting device 31 can also be replaced with the reed 33 shown in FIG. 7 and FIG. 8, respectively. Alternatively, the base 3 can be replace with a night lamp, a lighting lamp or a decorative lamp.

In sum, the present invention discloses a lamp structure having a lampshade presenting metallic shine, which achieves sight effect. A mass of metallic string placed in the lampshade is illuminated by an illuminator also accommodated in the lampshade, thus presents metallic shine and achieve sight effect. The colors of the lampshade, the illuminator and metallic string can vary depending on the designs to achieve different sight effects.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

1. A lamp structure, comprising:
a lampshade, having an opening;
a mass of metallic string, formed in the lampshade;
a base, connected with the opening of the lampshade; and
an illuminator, electrically connected with the base, and being accommodated in the lampshade.

2. The lamp structure according to claim 1, wherein said lampshade is chosen from lampshades with different colors.

3. The lamp structure according to claim 1, wherein said metallic string is chosen from metallic strings with different colors.

4. The lamp structure according to claim 1, wherein said illuminator is chosen from illuminators with different colors.

5. The lamp structure according to claim 1, wherein said mass of string is made of entangled strings.

6. The lamp structure according to claim 1, further comprises a connecting device used to connect said opening with said lampshade.

7. A lamp structure, comprising:
a lampshade, having an opening; and
a mass of metallic string, formed in the lampshade.
